(19) United States
(12) Patent Application Publication
(10) Pub. No.: US 2005/0136707 A1
(43) Pub. Date: Jun. 23, 2005

(54) Electric junction box

(75) Inventor: Hirotaka Kiyota, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAKAKI CORPORATION, Tokyo (JP)

(21) Appl. No.: 10/994,517

(22) Filed: Nov. 23, 2004

(30) Foreign Application Priority Data
Nov. 27, 2003 (JP) 2003-397164

(51) Int. Cl. H01R 31/08

(52) U.S. Cl. 439/76.2

(57) ABSTRACT

The electric junction box includes: a first electric junction box body; a second electric junction box body being incorporated with the first electric junction box body; and an external cover member for receiving the incorporated first and second electric junction box bodies therein, electric wires being guided out to the outside from an electric wire-guiding out hole of the external cover member, wherein a first incorporation face and an opposite second incorporation face of the second electric junction box body are provided with an engaging part for incorporation with the first electric junction box body, and wherein a first incorporation face and an opposite second incorporation face of the first electric junction box body are provided with a mating engaging part for incorporation with the second electric junction box body.

### BACKGROUND OF THE INVENTION

(1) Field of the Invention

The present invention relates to an electric junction box, in which a plurality of electric junction box bodies are incorporated.

(2) Description of the Related Art

Such an electric junction box is disclosed in Japanese Patent Application Laid-Open No. H8-140240 and shown in FIG. 7.

As shown in FIG. 7, the electric junction box 100 includes a first electric junction box body 101, second electric junction box body 102, and external cover member 103, wherein the first and second electric junction box bodies are divided from each other based on their functions. Each incorporation face of the first and second electric junction box bodies 101, 102 is provided with an engaging part 101a and a mating engaging part 102a, respectively. The incorporation face of the first electric junction box body 101 is joined with the incorporation face of the second electric junction box body 102, then the engaging part 101a is engaged with the mating engaging part 102a, thereby the first and second electric junction box bodies 101, 102 are incorporated with each other. The incorporated first and second electric junction box bodies 101, 102 are received in the external cover member 103. An outer circumferential face of the first electric junction box body 101 is provided with an engaging part 101b. An inner circumferential face of the external cover member 103 is provided with a mating engaging part 103b. The engaging part 101b is engaged with the mating engaging part 103b, thereby the first electric junction box body 101 is fixed to the external cover member 103. The external cover member 103 is provided with two electric wire-guiding out holes 103c, 103d, through which a plurality of electric wires (not shown in FIG. 7) connected to lower faces of the first and second electric junction box bodies 101, 102 are guided out to the outside.

Because of the demand for high density mounting, a space for mounting the electric junction box 100 in a vehicle with a vehicle body having a right steering wheel is often reverse of a space for mounting the electric junction box 100 in a vehicle with a vehicle body having a left steering wheel. In such a case, an outer shape of the electric junction box 100 is required to be variable to meet the requirement depending on the vehicle body, which has either a right steering wheel or left steering wheel.

Since the outer shape of the external cover member 103 is generally formed asymmetrical right and left matching with the sizes of the first and second electric junction box bodies 101, 102, it can be easily considered that the electric junction box 100 itself is mounted in a vehicle being rotated by 180° in order to match its outer shape with a mounting space, which is inversely rotated right and left. However, if the mounting position of the electric junction box 100 is simply rotated by 180°, the positions of the electric wire-guiding out holes 103c, 103d of the external cover member 103 are also rotated by 180°, causing a problem that the length of the electric wires (not shown in FIG. 7) become excessively long or excessively short.

### SUMMARY OF THE INVENTION

It is therefore an objective of the present invention to solve the above problem and to provide an electric junction box, the outer shape of which can be changed to an outer shape that is reversed right and left in response to the mounting space without changing the positions where the wires are guided out from the external cover member substantially.

In order to attain the above objective, the present invention is to provide an electric junction box including:
a first electric junction box body;
a second electric junction box body being incorporated with the first electric junction box body; and
an external cover member for receiving the incorporated first and second electric junction box bodies therein, electric wires being guided out to the outside from an electric wire-guiding out hole of the external cover member,
wherein first and second incorporation faces of the second electric junction box body are provided with an engaging part for incorporation with the first electric junction box body, the second incorporation face of the second electric junction box body being located on an opposite side of the first incorporation face of the second electric junction box body,
and wherein first and second incorporation faces of the first electric junction box body are provided with a mating engaging part for incorporation with the second electric junction box body, the second incorporation face of the first electric junction box body being located on an opposite side of the first incorporation face of the first electric junction box body.

As for the electric junction box, since the first and second electric junction box bodies can be incorporated with each other by joining the respective first incorporation faces together or, alternatively, by joining the respective second incorporation faces together, therefore a shape of the electric junction box can be changed to a shape reversed right and left by changing the incorporation position. Accordingly, the shape of the electric junction box can be changed to a shape reversed right and left in response to a mounting space without changing the positions where the wires are guided out from the external cover member substantially.

Preferably, the electric junction box further includes a third electric junction box body being incorporated with both of the first and second electric junction box bodies, wherein the third electric junction box body is provided with engaging parts for fixing to the external cover member at a plurality of positions of the third electric junction box body.

With the construction described above, the number of the engaging parts of the first and second electric junction box bodies can be set minimal, thereby enabling the increase in the degree of freedom for designing the first and second electric junction box bodies.

Preferably, the first and second electric junction box bodies are provided with an engaging part for fixing to the external cover member.

With the construction described above, each of the first and second electric junction box bodies is directly fixed to the external cover member. Therefore, the first and second electric junction box bodies can be firmly fixed to the external cover member.

Preferably, an engaging part for fixing to the external cover member is provided on one of outer circumferential faces which face to each other along the incorporation face of the incorporated electric junction box bodies.

With the construction described above, since the engaging part for fixing to the external cover member and the mating engaging part for incorporation with the electric junction box body can be saved with respect to a direction in which the electric junction box bodies are joined together, therefore a size of the electric junction box body in the direction can be made small.

### BRIEF DESCRIPTION OF THE DRAWINGS

FIG. 1 is an exploded perspective view of an electric junction box for a vehicle body having a right steering wheel according to a preferred embodiment of the present invention;

FIG. 2 is a plan view of inner assembly assembled for a vehicle body having a right steering wheel according to a preferred embodiment of the present invention;

FIG. 3 is a plan view illustrating a state when the inner assembly assembled for a vehicle body having a right steering wheel is received in an external cover member for the right according to a preferred embodiment of the present invention;

FIG. 4 is an exploded perspective view of an electric junction box for a vehicle body having a left steering wheel according to a preferred embodiment of the present invention;

FIG. 5 is a plan view of inner assembly assembled for a vehicle body having a left steering wheel according to a preferred embodiment of the present invention;

FIG. 6 is a plan view illustrating a state when the inner assembly assembled for a vehicle body having a left steering wheel is received in an external cover member for the left according to a preferred embodiment of the present invention; and

FIG. 7 is a partial exploded perspective view illustrating an example of a conventional electric junction box.

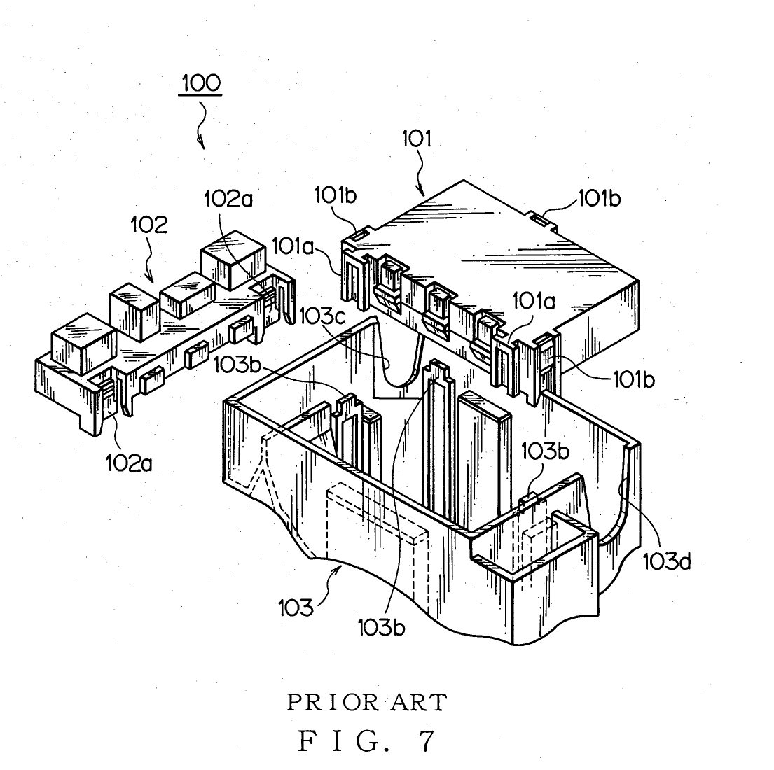

### DESCRIPTION OF THE PREFERRED EMBODIMENTS

In the following, the preferred embodiments of the present invention will be explained with reference to the attached drawings.

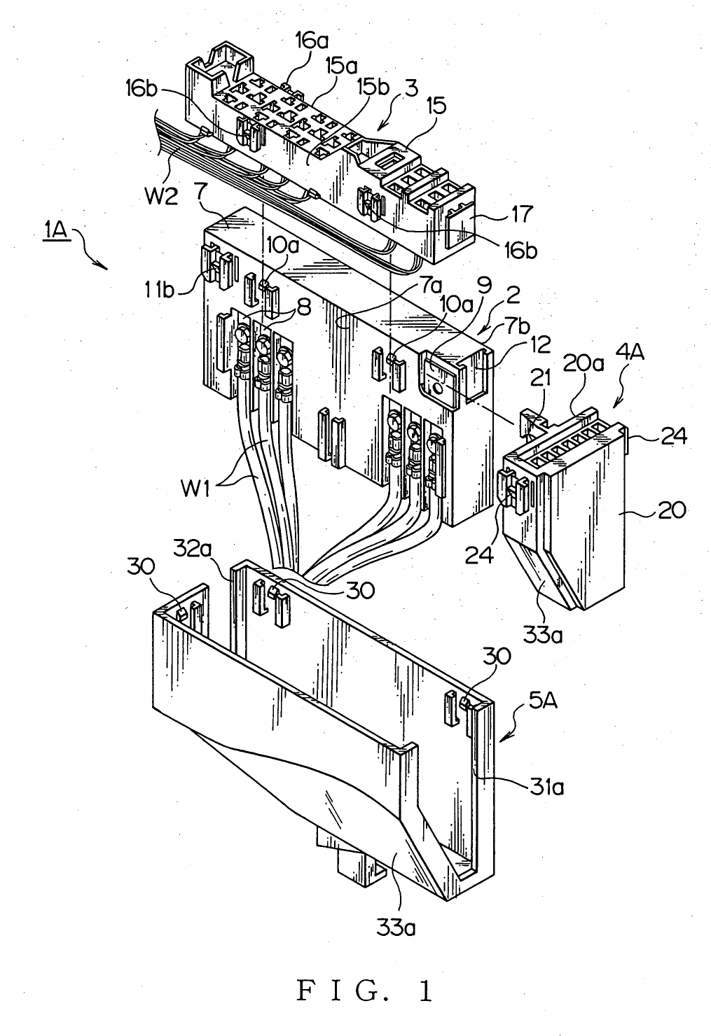

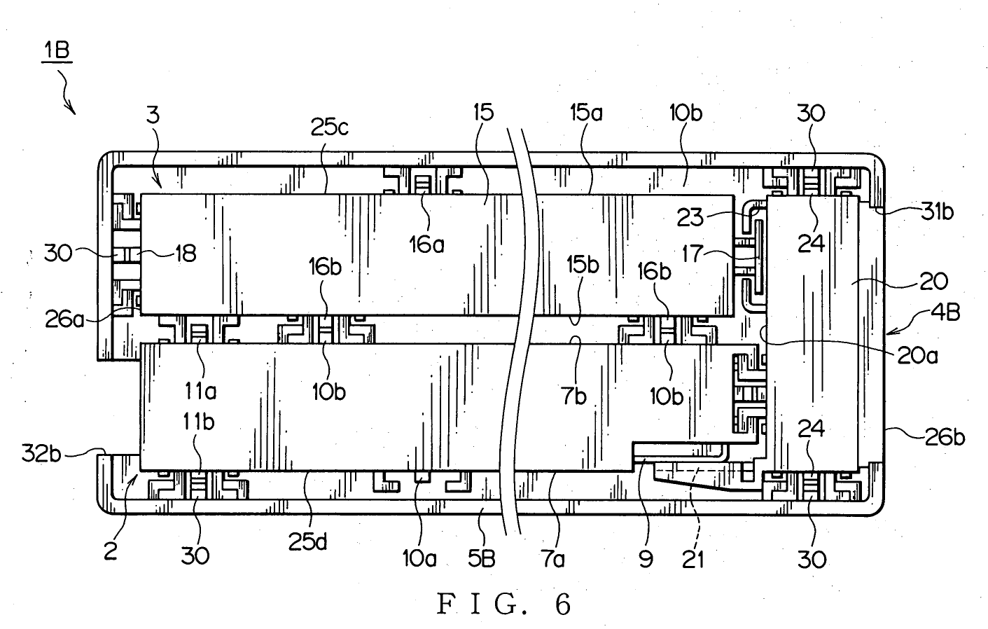

FIGS. 1-6 show the preferred embodiments of the present invention.

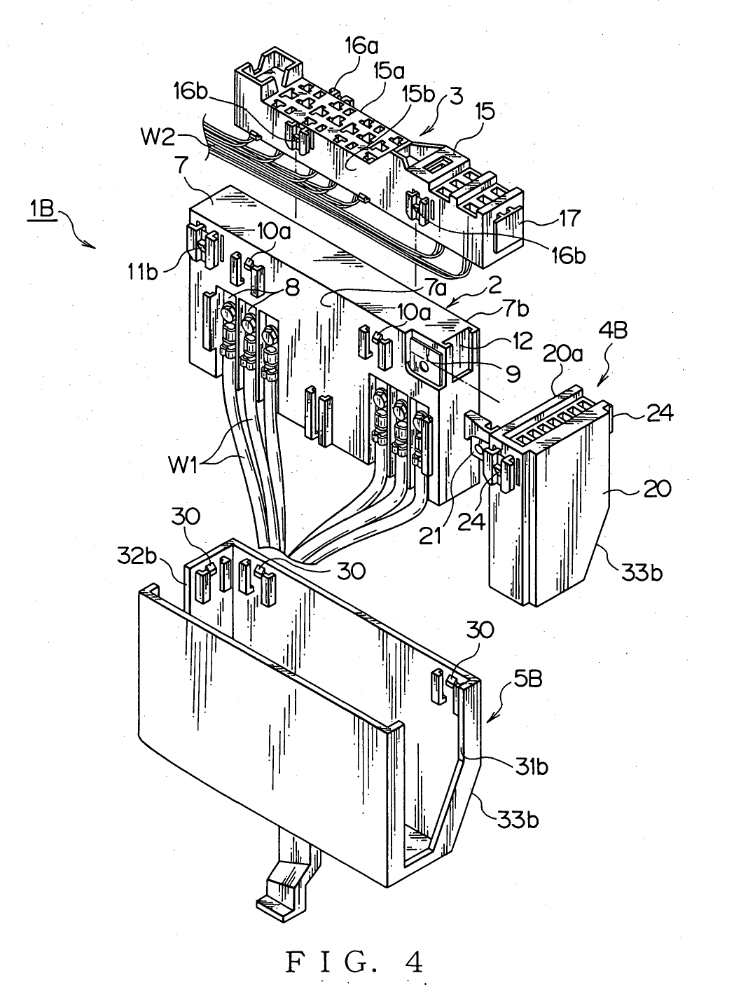

As shown in FIGS. 1-3, the electric junction box 1A for a vehicle body having a right steering wheel includes a first electric junction box body 2, a second electric junction box body 3, a third electric junction box body 4A for the right, and an external cover member 5A for the right. As shown in FIGS. 4-6, the electric junction box 1B for a vehicle body having a left steering wheel includes the first electric junction box body 2, the second electric junction box body 3, a third electric junction box body 4B for the left, and an external cover member 5B for the left. That is, both of the electric junction boxes 1A and 1B include the first and second electric junction box bodies 2 and 3 in common.

As shown in FIGS. 1-3, the first electric junction box body 2 includes: busbars which constitute a specific branch circuit and a plurality of fusible link parts; and a housing 7 in which the busbars and so on are arranged. In the busbar, there are formed a plurality of terminal parts 8, parts of which are arranged so as to be exposed on a first incorporation face 7a. An end of each electric wire W1 is fixed to the corresponding terminal part 8 by a bolt or the like. In the busbar, there is formed a connection terminal part 9, to which a connection terminal part 21 of the third electric junction box body 4A for the right or the third electric junction box body 4B for the left is fixed by a bolt or the like.

On the first incorporation face 7a of the housing 7, there are formed mating engaging parts 10a for incorporation with the second electric junction box body and an engaging part 11b for fixing to the external cover member. On the second incorporation face 7b located on the opposite side of the first incorporation face 7a of the housing 7, there are also formed mating engaging parts 10b for incorporation with the second electric junction box body and an engaging part 11a for fixing to the external cover member. Further, on a side face of the housing 7, which side face crosses at right angles with the first incorporation face 7a and the second incorporation face 7b, there is formed a slide groove 12 for incorporation with the third electric junction box body.

The second electric junction box body 3 includes a housing 15, in which a plurality of relay parts (not shown in the figure) and fuse parts (not shown in the figure) are mounted. A plurality of electric wires W2 are guided out from a bottom face of the housing 15. On the first incorporation face 15a of the housing 15, there are formed two engaging parts 16a for incorporation with the first electric junction box body at respective positions. On the second incorporation face 15b located on the opposite side of the first incorporation face 15a of the housing 15, there are formed two engaging parts 16b for incorporation with the first electric junction box body at respective positions. Further, on a side face of the second electric junction box body 3, which side face crosses at right angles with the first incorporation face 15a and the second incorporation face 15b, there is formed a slide projection 17 for incorporation with the third electric junction box body. Furthermore, on the opposite side face of the second electric junction box body 3, there is formed an engaging part 18 for fixing to the external cover member.

As shown in FIGS. 1-3, the third electric junction box body 4A for the right includes a housing 20, in which a plurality of fuse parts (not shown in the figure) are mounted. Busbars are arranged in the housing 20. A part of the busbars forms the connection terminal part 21, which is connected to the connection terminal part 9 of the first electric junction box body 2 as described above. On an incorporation face 20a of the housing 20, there are formed a slide projection 22 for incorporation with the first electric junction box body and a slide groove 23 for incorporation with the second electric junction box body. On both outer faces of the housing 20, there are formed respective engaging parts 24 for fixing to the external cover member.

As shown in FIGS. 4-6, in the third electric junction box body 4B for the left, the position of the connection terminal part 21 is different compared to that in the third electric junction box body 4A for the right and is constructed so as to have an outer shape being formed reverse right and left to that of the third electric junction box body 4A for the right. That is, in comparison with the third electric junction box body 4A for the right, both positions of the slide projection 22 and slide groove 23 are set reverse right and left. The other constitution is the same.

As shown in FIGS. 1-3, the whole upper face of the external cover member 5A for the right are made open. From the upper face, the first electric junction box body 2 and so on are received. At four positions on inner surfaces of the external cover member 5A for the right, there are formed respective mating engaging parts 30 for incorporation with the electric junction box body. On a side face of the external cover member 5A for the right, there is formed a slide engaging groove 31a for incorporation with the third electric junction box body, while on the other side face of the external cover member 5A for the right, there is formed an electric wire-guiding out hole 32a. As for an outer shape of the external cover member 5A for the right, there is formed a hollow shaped part 33a on the side face of receiving the second electric junction box body 3.

As shown in FIGS. 4-6, in the external cover member 5B for the left, the two positions of the mating engaging parts 30 for incorporation with the electric junction box body are different compared to those in the external cover member 5A for the right. Although a slide engaging groove 31b for incorporation with the third electric junction box body and an electric wire-guiding out hole 32b are formed on the same corresponding side face, they have a reverse shape right and left compared to those of the slide engaging groove 31a and electric wire-guiding out hole 32a, respectively, and they are positioned at respective symmetrical positions right and left. As for an outer shape of the external cover member 5B for the left, there is formed a hollow shaped part 33b on the side face reverse right and left compared to the outer shape of the external cover member 5A for the right.

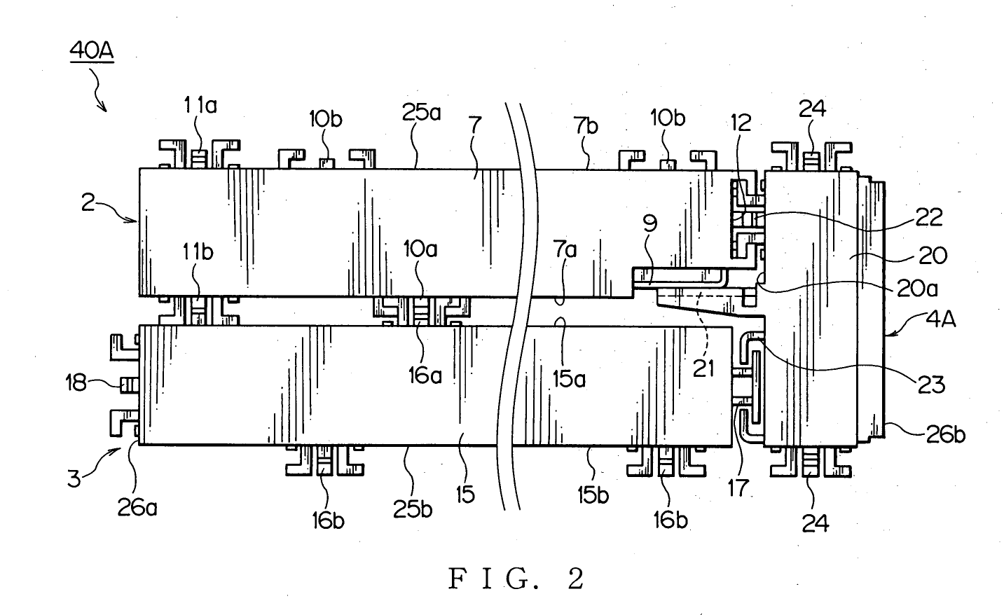

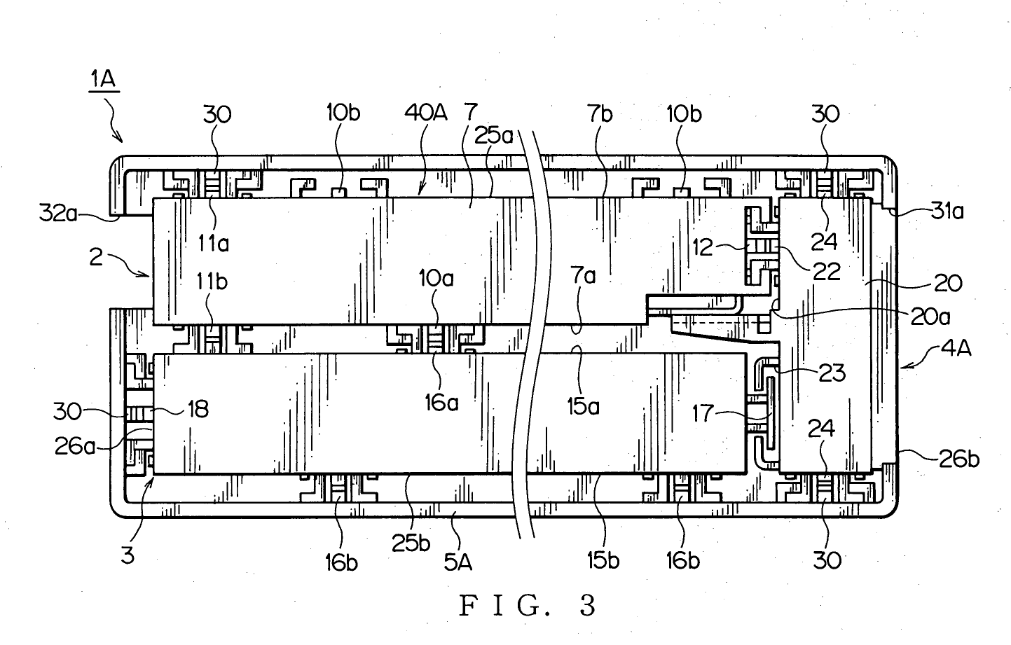

In the following, assembling sequence of the electric junction box 1A for a vehicle body having a right steering wheel will be explained. As shown in FIGS. 1 and 2, the third electric junction box body 4A for the right is incorporated with the first electric junction box body 2. Then, the second electric junction box body 3 is incorporated with the first incorporation face 7a of the first electric junction box body 2 so as to form an inner assembly 40A for the right. Then, as shown in FIG. 3, the engaging part 11a for fixing to the cover member of the inner assembly 40A for the right is positioned to the engaging part 30 for incorporation with the electric junction box body in the external cover member 5A for the right, and the inner assembly 40A for the right is received into the external cover member 5A for the right. The wires W1 and W2 are guided out to the outside from the electric wire-guiding out hole 32a of the external cover member 5A for the right.

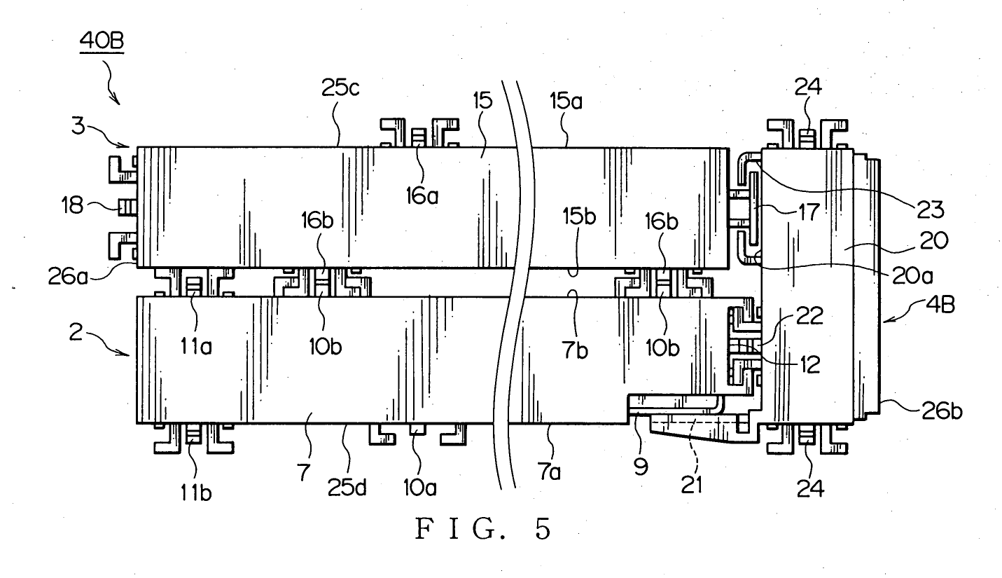

In the following, assembling sequence of the electric junction box 1B for a vehicle body having a left steering wheel will be explained. As shown in FIGS. 3 and 4, the third electric junction box body 4B for the left is incorporated with the first electric junction box body 2. Then, the second electric junction box body 3 is incorporated with the second incorporation face 7b of the first electric junction box body 2 so as to form an inner assembly 40B for the left. Then, as shown in FIG. 5, the engaging part 11b for fixing to the external cover member of the inner assembly 40B for the left is positioned to the engaging part 30 for incorporation with the electric junction box body in the external cover member 5B for the left, and the inner assembly 40B for the left is received into the external cover member 5B for the left. The wires W1 and W2 are guided out to the outside from the electric wire-guiding out hole 32b of the external cover member 5B for the left.

As shown in FIGS. 1-3, in the inner assembly 40A for the right, there is formed the engaging part 11a for fixing to the external cover member on an outer circumferential face 25a, of the outer circumferential face 25a and an outer circumferential face 25b, which face to each other along the first incorporation face 7a of the housing 7 as a face on which the incorporated first and second electric junction box bodies 2 and 3 are piled up and along the first incorporation face 15a of the housing 15. Further, there is formed an engaging part 18 for fixing to the external cover member on an outer circumferential face 26a, of the outer circumferential face 26a and an outer circumferential face 26b, which face to each other along the third incorporation face 15c of the housing 15 as a face on which the incorporated second and third electric junction box bodies 3 and 4A are piled up and along the incorporation face 20a of the housing 20.

As shown in FIGS. 4-6, in the inner assembly 40B for the left, there is formed the engaging part 11b for fixing to the external cover member on an outer circumferential face 25d, of the outer circumferential face 25d and an outer circumferential face 25c, which face to each other along the second incorporation face 7b of the housing 7 as a face on which the incorporated first and second electric junction box bodies 2 and 3 are piled up and along the second incorporation face 15b of the housing 15. Further, there is formed an engaging part 18 for fixing to the external cover member on an outer circumferential face 26a, of the outer circumferential face 26a and an outer circumferential face 26b, which face to each other along the third incorporation face 15c of the housing 15 as a face on which the incorporated second and third electric junction box bodies 3 and 4B are piled up and along the incorporation face 20a of the housing 20.

As for the electric junction box 1A, 1B, since the first and second electric junction box bodies 2 and 3 can be incorporated with each other by joining the respective first incorporation faces 7a, 15a together or, alternatively, by joining the respective second incorporation faces 7b, 15b together, therefore a shape of the electric junction box can be changed to a shape reversed right and left by changing the incorporation position. Accordingly, the shape of the electric junction box can be changed to a shape reversed right and left in response to a mounting space without changing the positions where the wires W1, W2 are guided out from the external cover member 5A, 5B substantially.

In the preferred embodiment, the electric junction box further includes the third electric junction box body 4A or 4B being incorporated with both of the first and second electric junction box bodies 2 and 3, wherein the third electric junction box body 4A or 4B is provided with engaging parts 24 for fixing to the external cover member 5A or 5B at a plurality of positions of the third electric junction box body 4A or 4B. Therefore, the number of the engaging parts 11a, 11b, 18 of the first and second electric junction box bodies 2 and 3 can be set minimal, thereby enabling the increase in the degree of freedom for designing the first and second electric junction box bodies 2 and 3.

In the preferred embodiment, the first and second electric junction box bodies 2 and 3 are provided with respective engaging parts 11a, 11b 18 for fixing to the external cover member 5A or 5B. Therefore, each of the first and second electric junction box bodies 2, 3 is directly fixed to the external cover member 5A or 5B. Therefore, the first and second electric junction box bodies 2, 3 can be firmly fixed to the external cover member 5A or 5B.

In the preferred embodiments described above, the first electric junction box body 2, the second electric junction box body 3 and the third electric junction box body 4A or 4B are incorporated together. However, in the present invention, only the first electric junction box body 2 and second electric junction box body 3 may be incorporated together. Alternatively, in the present invention, the first electric junction box body 2, the second electric junction box body 3, the third electric junction box body 4A or 4B, and one or more electric junction box bodies may be incorporated together.

1. An electric junction box comprising:
a first electric junction box body;
a second electric junction box body being incorporated with the first electric junction box body; and
an external cover member for receiving the incorporated first and second electric junction box bodies therein, electric wires being guided out to the outside from an electric wire-guiding out hole of the external cover member,
wherein first and second incorporation faces of the second electric junction box body are provided with an engaging part for incorporation with the first electric junction box body, the second incorporation face of the second electric junction box body being located on an opposite side of the first incorporation face of the second electric junction box body,
and wherein first and second incorporation faces of the first electric junction box body are provided with a mating engaging part for incorporation with the second electric junction box body, the second incorporation face of the first electric junction box body being located on an opposite side of the first incorporation face of the first electric junction box body.

2. The electric junction box according to claim 1, further comprising a third electric junction box body being incorporated with both of the first and second electric junction box bodies, wherein the third electric junction box body is provided with engaging parts for fixing to the external cover member at a plurality of positions of the third electric junction box body.

3. The electric junction box according to claim 1, wherein the first and second electric junction box bodies are provided with an engaging part for fixing to the external cover member.

4. The electric junction box according to claim 2, wherein the first and 5 second electric junction box bodies are provided with an engaging part for fixing to the external cover member.

5. The electric junction box according to claim 2, wherein an engaging part for fixing to the external cover member is provided on one of outer circumferential faces which face to each other along the incorporation face of the incorporated electric junction box bodies.

6. The electric junction box according to claim 3, wherein an engaging part for fixing to the external cover member is provided on one of outer circumferential faces which face to each other along the incorporation face of the incorporated electric junction box bodies.

7. The electric junction box according to claim 4, wherein an engaging part for fixing to the external cover member is provided on one of outer circumferential faces which face to each other along the incorporation face of the incorporated electric junction box bodies.
